(19) United States
(12) Patent Application Publication
(10) Pub. No.: US 2011/0253235 A1
(43) Pub. Date: Oct. 20, 2011

(54) Arrangement For Adjusting An Aircraft Propeller

(75) Inventor: Matthias Bohm, Erlbach-Kirchberg (DE)

(73) Assignee: THEILERT AIRCRAFT ENGINES GMBH, Lichtenstein (DE)

(21) Appl. No.: 13/127,882

(22) PCT Filed: Sep. 1, 2009
(86) PCT No.: PCT/EP2009/061298

§ 371 Date: Jun. 24, 2011

(30) Foreign Application Priority Data
Nov. 7, 2008 (DE) 102008043587.2

(51) Int. Cl. F17D 3/00

(52) U.S. Cl. 137/565.15

(57) ABSTRACT

An arrangement for the hydraulic adjustment of the propeller blades of an aircraft propeller (1) with the help of a hydraulic pump (5) having a hydraulic cylinder (3) which is acted upon by compressed oil comprises a pressure control valve (11) arranged parallel to the hydraulic pump and connected directly to the pressure connection (4) and intake connection (8) thereof, preferably integrated into the pump housing (14). The pump losses and heating of the oil are therefore reduced and hydraulic efficiency is improved.

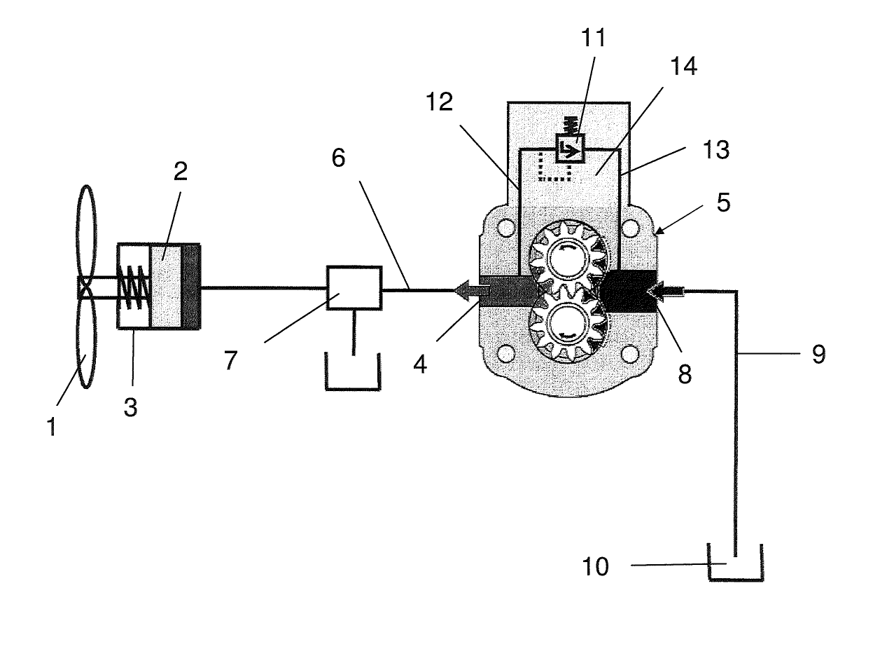

### TECHNICAL FIELD

The invention relates to an arrangement for the hydraulic adjustment of the propeller blades of an aircraft propeller by means of a hydraulic cylinder which is connected to a hydraulic pump by way of a pressure control valve.

### BACKGROUND

As is known, in the field of aviation, propellers with adjustable propeller blades (variable pitch propellers) are used whose blade angle in this way can be adjusted to various operational situations, in particular during takeoff and landing and when taxiing on the airfield. In a known arrangement for adjusting the propeller blades, the latter are connected, by way of an actuating mechanism, to the piston that is actuated in a hydraulic cylinder as a result of the energy of a hydraulic fluid. The hydraulic fluid is provided at a constant volume and at a defined pressure by way of a pressure pipe from a hydraulic pump that on the suction side is connected to a hydraulic fluid reservoir, for example an oil container or the transmission casing. A pressure control valve and propeller control hydraulics are integrated in the pressure pipe. The pressure control valve limits the pressure to a constant maximum desired pressure in that when the desired pressure is exceeded, the pressure control valve opens and returns by way of a return pipe into the oil container excess hydraulic fluid supplied by the hydraulic pump until such time as the pressure drops below the desired pressure. In practical operation a constant hydraulic fluid circulation system is maintained from the oil container by way of the suction pipe, the hydraulic pump, the pressure pipe, the pressure control valve and the long return pipe back to the oil container. The constant oil circulation over a considerable distance results in flow losses and associated heating of the oil, and ultimately in a reduction in the efficiency of the entire hydraulic system.

### SUMMARY OF THE INVENTION

It is the object of the invention to further develop the arrangement, mentioned in the introduction, for the hydraulic adjustment of the propeller blades of an aircraft propeller in such a manner that the efficiency of the hydraulic system is improved.

According to the invention the object is met by an arrangement for the hydraulic adjustment of the propeller blades, and more particularly by an arrangement for the hydraulic adjustment of the propeller blades of an aircraft propeller by means of a hydraulic cylinder which is connected by way of a pressure control valve to the pressure connection of a hydraulic pump that on the suction connection is connected to a hydraulic fluid reservoir, characterised in that the pressure control valve is arranged parallel to the hydraulic pump between the pressure connection and the suction connection. Expedient embodiments of the invention are discussed further below.

In other words, the basic idea of the invention consists of returning the oil volume in the shortest way to the hydraulic oil circulation system, which oil volume for setting a constant pressure acting on the hydraulic cylinder is branched off at the pressure control valve, in that the pressure control valve is arranged parallel to the hydraulic pump and is directly connected to the pressure connection and the suction connection of said hydraulic pump. In this manner both heating and foaming of the hydraulic oil are minimised and pump losses are reduced so that ultimately improved efficiency of the hydraulic system can be achieved.

Preferably, the pressure control valve and the corresponding connection pipes to the pressure connection and to the suction connection of the hydraulic pump are integrated in the pump casing so that oil that has been branched off for setting the desired value in fact travels the shortest distance and so that, furthermore, a compact design is made possible.

In an embodiment of the invention the hydraulic pump is a gear pump, preferably an external gear pump. Supplying the hydraulic fluid from the pressure connection of the hydraulic pump to the hydraulic cylinder takes place by way of propeller control hydraulics on the basis of a 3/2-way valve.

### BRIEF DESCRIPTION OF THE DRAWING

An exemplary embodiment of the invention is explained in more detail with reference to the drawing, which diagrammatically shows an arrangement for the hydraulic adjustment of the propeller blades of an aircraft.

### DETAILED DESCRIPTION OF THE INVENTION

As diagrammatically indicated in the drawing, the blade pitch of an aircraft propeller 1 is adjusted by means of a single-acting hydraulic cylinder 3 which on one side of the hydraulic piston 2 is impinged on by hydraulic oil (hydraulic fluid). Supplying the hydraulic oil to the hydraulic cylinder 3 takes place from the pressure connection 4 of a hydraulic pump 5 that is designed as an external gear pump by way of a pressure pipe 6 and propeller control hydraulics 7 incorporated in said pressure pipe 6. The suction connection 8 of the hydraulic pump 5 is connected by way of a suction pipe 9 to a hydraulic fluid reservoir 10, in the present embodiment an oil container or a gear casing. The hydraulic pump 5 generates a continuous volume flow of the hydraulic oil that reaches the hydraulic cylinder 3 under pressure. A pressure control valve 11, which is necessary to delimit a determined maximum desired pressure acting on the hydraulic cylinder 3, is arranged parallel and in close proximity to the hydraulic pump 5 and by way of a short auxiliary pressure pipe 12 is connected directly to the pressure connection 4 and by means of a short return pipe 13 is connected directly to the suction connection 8 of the hydraulic pump 5. In the present embodiment the pressure control valve 11 is integrated in the pump casing 14 of the hydraulic pump 5 so that the hydraulic oil branched off for pressure control only needs to travel very short distances.

As a result of the return of the excess oil that arises for pressure control on the pressure control valve 11 at the shortest distance directly to the suction connection 8, flow losses and the associated heating of the hydraulic oil are significantly reduced when compared to those of known arrangements for hydraulic propeller adjustment, in which arrangements the branched-off oil flows back to the gear casing 10 by way of a long return pipe and thus needs to be conveyed over a long path. Due to the low losses and the oil quality that is not negatively affected as a result of heat, the required drive output of the hydraulic pump 5 is reduced so that the efficiency of the hydraulic system for propeller adjustment is improved. Furthermore, incorporating the pressure control valve 11 in the pump casing makes it possible to achieve a compact design.

List of Reference Characters
1 Aircraft propeller
2 Hydraulic piston
3 Hydraulic cylinder
4 Pressure connection
5 Hydraulic pump, gear pump
6 Pressure pipe
7 Propeller control hydraulics
8 Suction connection
9 Suction pipe
10 Hydraulic fluid reservoir, transmission casing, oil container
11 Pressure control valve
12 Auxiliary pressure pipe
13 Return pipe
14 Pump casing

1. An arrangement for the hydraulic adjustment of the propeller blades of an aircraft propeller (1) comprising:
a hydraulic cylinder (3) which is connected by way of a pressure control valve (11) to a pressure connection (4) of a hydraulic pump (5) that on a suction connection (8) thereof is connected to a hydraulic fluid reservoir (10), the pressure control valve (11) being arranged parallel to the hydraulic pump (5) between the pressure connection (4) and the suction connection (8).

2. The arrangement according to claim 1, wherein the pressure control valve (11) has connection pipes (12, 13) for connection with the pressure connection (4) and the suction connection (8), the pressure control valve and the connection pipes being integrated in a pump casing (14) of the hydraulic pump (5).

3. The arrangement according to claim 1, wherein the hydraulic fluid reservoir (10) is formed by a transmission casing.

4. The arrangement according to claim 1, wherein the hydraulic pump (5) is a gear pump.

5. The arrangement according to claim 1, wherein a supply of the hydraulic fluid from the pressure connection of the hydraulic pump (5) to the hydraulic cylinder (3) passes through propeller control hydraulics (7) including a 3/2-way valve.

6. The arrangement according to claim 1, wherein the hydraulic fluid reservoir (10) is formed by an oil container.

7. The arrangement according to claim 2, wherein the hydraulic fluid reservoir (10) is formed by a transmission casing.

8. The arrangement according to claim 2, wherein the hydraulic fluid reservoir (10) is formed by an oil container.

9. The arrangement according to claim 2, wherein a supply of the hydraulic fluid from the pressure connection of the hydraulic pump (5) to the hydraulic cylinder (3) passes through propeller control hydraulics (7) including a 3/2-way valve.
